(19) United States
(12) Patent Application Publication
(10) Pub. No.: US 2026/0094941 A1
(43) Pub. Date: Apr. 2, 2026

(54) SEPARATOR, ELECTROCHEMICAL APPARATUS, AND ELECTRONIC APPARATUS

(71) Applicant: Ningde Amperex Technology Limited, Ningde (CN)

(72) Inventors: Xiaohe FAN, Ningde (CN); Zengbin WEI, Ningde (CN); Xianhui XIE, Ningde (CN)

(73) Assignee: Ningde Amperex Technology Limited, Ningde (CN)

(21) Appl. No.: 19/344,671

(22) Filed: Sep. 30, 2025

(30) Foreign Application Priority Data
Sep. 30, 2024 (CN) 202411388898.4

(51) Int. Cl. H01M 50/46; C09J 125/14; H01M 50/417; H01M 50/42; H01M 50/434; H01M 50/443; H01M 50/446; H01M 50/451; H01M 50/491

(52) U.S. Cl. CPC H01M 50/461; C09J 125/14; H01M 50/417; H01M 50/42; H01M 50/434; H01M 50/443; H01M 50/446; H01M 50/451; H01M 50/491

(57) ABSTRACT

A separator includes a substrate layer, an inorganic coating, and a bonding layer, where the inorganic coating is disposed between the substrate layer and the bonding layer, and the bonding layer contains a plurality of bonded particles, a surface of each bonded particle containing a plurality of protrusions, an average diameter of the protrusions ranges from 20 nm to 100 nm. The separator provided by this application is conducive to improving the cycle performance, low-temperature performance and rate performance of the electrochemical apparatus.

### CROSS REFERENCE TO RELATED APPLICATIONS

This application claims priority to the Chinese Patent Application No. 202411388898.4, filed on Sep. 30, 2024, the content of which is incorporated herein by reference in its entirety.

### TECHNICAL FIELD

This application relates to the field of electrochemical energy storage, and in particular, to a separator, an electrochemical apparatus using the separator, and an electronic apparatus using the electrochemical apparatus.

### BACKGROUND

Electrochemical apparatuses (e.g., lithium-ion batteries), as portable chemical energy sources, are widely used in fields and industries such as consumer electronics (e.g., mobile phones, laptops, cameras, etc.), energy storage products (e.g., home energy storage, energy storage power stations, UPS power supplies, etc.), and new energy vehicles due to their advantages of high energy density, high operating voltage platform, small self-discharge, long service life, and environmental friendliness.

With the development of the new energy industry, higher requirements are imposed on the electrochemical apparatuses. A separator, as an important part of an electrochemical apparatus, affects transmission of an electrolyte solution and an interface structure of the electrochemical apparatus, which are related to the low-temperature performance and cycle performance of the electrochemical apparatus. Therefore, it is necessary to provide a separator that can improve both the low-temperature performance and cycle performance of the electrochemical apparatus.

### SUMMARY

This application provides a separator, an electrochemical apparatus, and an electronic apparatus.

A first aspect of this application provides a separator, including a substrate layer, an inorganic coating, and a bonding layer. The inorganic coating is disposed between the substrate layer and the bonding layer. The bonding layer contains a plurality of bonded particles. A surface of each bonded particle contains a plurality of protrusions, an average diameter of the protrusions ranges from 20 nm to 100 nm.

According to the separator in this application, the surface of each bonded particle contains a plurality of protrusions, the formation of the protrusions increases contact sites between the bonding layer and a positive electrode plate or a negative electrode plate, which is conducive to increasing interface bonding forces between the bonding layer and electrode plates. Moreover, the protrusions can further be embedded in a positive active material layer or a negative active material layer to further increase the bonding forces between the bonding layer and the electrode plates, thereby helping to improve the cycle performance and energy density of the electrochemical apparatus. Each bonded particle contains a plurality of protrusions. The protrusions increase the volume of the bonded particle, which is conducive to improving the capacity of the separator to retain an electrolyte solution, and in turn, conducive to improving conduction of lithium ions as well as improving the cycle performance and low-temperature performance of the electrochemical apparatus. Moreover, the average diameter of the protrusions is within the above range, such that the protrusions can come into full contact with the active material layers in the electrode plates to maintain good bonding forces. Moreover, it is also conducive to improving transmission of the electrolyte solution between the bonding layer and the active material layers in the electrode plates, and in turn, conducive to improving conduction of active ions, thereby improving the cycle performance, low-temperature performance and rate performance of the electrochemical apparatus. Further preferably, the protrusions have an average diameter of 40 nm to 100 nm, which can even further improve the cycle performance, low-temperature performance and rate performance of the electrochemical apparatus.

On the basis of the first aspect, in some embodiments, part of the adjacent bonded particles are connected to each other, and the number of the connected bonded particles accounts for more than 50% of the total number of the bonded particles. Part of the adjacent bonded particles are connected to form a mesh structure, which can increase the interface bonding force between the positive electrode plate and the negative electrode plate when the bonded particles are bonded to the positive electrode plate or the negative electrode plate, thereby helping to improve the cycle performance of the electrochemical apparatus.

On the basis of the first aspect, in some embodiments, an absorption peak of —COOH is presented at 1680 cm⁻¹ to 1750 cm⁻¹ in an infrared spectrum of the bonding layer, and transmittance of the absorption peak is 50% to 95%. The carboxyl absorption peak is presented in the bonding layer, and carboxyl has polarity, which is conducive to improving the performance of the electrolyte solution in infiltrating the separator and also conducive to increasing a bonding force of the bonding layer. The transmittance of the absorption peak is within the above range, such that the bonding layer contains an appropriate number of protrusions, which enables the bonding layer to have a good bonding force and is also conducive to improving the performance of the electrolyte solution in infiltrating the separator, thereby improving the cycle performance and rate performance of the electrochemical apparatus.

On the basis of the first aspect, in some embodiments, in a scanning electron microscope image of the separator at a magnification of 10⁴, within an area of 11.6 μm×7.6 μm, the number of the bonded particles is 10 to 60. The number of the bonded particles is within the above range, such that the bonding layer has a good bonding force, and it is also conducive to improving the performance of the electrolyte solution in infiltrating the separator, thereby improving the cycle performance and rate performance of the electrochemical apparatus.

On the basis of the first aspect, in some embodiments, the number of protrusions contained in each bonded particle is 5 to 50. When it is satisfied that the number of protrusions on the surface of the bonding layer is appropriate within the above area, contact sites between the bonded particles and the positive and negative electrode plates are increased, and the bonding forces between the bonded particles and the positive and negative electrode plates are increased. The number of the protrusions being within the above range is conducive to further improving the bonding force between the bonded particles and the positive electrode plate or the negative electrode plate as well as the capacity of the separator to retain the electrolyte solution, and in turn, improving the cycle performance and kinetic performance of the electrochemical apparatus.

On the basis of the first aspect, in some embodiments, the inorganic coating includes inorganic particles and a binder. The inorganic particles include at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide, or barium sulfate. Based on the mass of the inorganic coating, a mass percent of the inorganic particles is 85% to 95%. The above inorganic particles can improve the mechanical strength of the separator and are also conducive to improving the effect of the electrolyte solution in infiltrating the separator and improving the cycle performance of the electrochemical apparatus.

On the basis of the first aspect, in some embodiments, the binder includes at least one of acrylic acid, methyl methacrylate, butyl acrylate, octyl acrylate, isooctyl acrylate, butadiene, or acrylonitrile. The above binder is conducive to increasing a bonding force between the inorganic particles in the inorganic coating and a bonding force between the inorganic coating and the substrate layer and to increasing an interface bonding force between the inorganic coating and the substrate layer, which is conducive to transmission of lithium ions, thereby improving the cycle performance of the electrochemical apparatus.

On the basis of the first aspect, in some embodiments, the bonded particles are formed by polymerization of at least two monomers selected from: butadiene, methyl acrylate, methyl methacrylate, styrene, butyl methacrylate, isooctyl acrylate, ethylene, propylene, or vinylidene fluoride. The bonded particles formed by polymerization of the above monomers have a good bonding force, such that the bonding layer can provide a certain bonding force. The bonding layer further include at least one of acrylic acid, acrylonitrile, or butadiene. The addition of the above substances can further improve the bonding force between the bonding layer and the inorganic coating, such that the bonding layer has a good bonding force and the performance of the electrolyte solution in infiltrating the separator, which is conducive to improving the kinetic performance of the electrochemical apparatus.

On the basis of the first aspect, in some embodiments, the inorganic coating has a thickness of 0.5 μm to 5 μm. The thickness of the inorganic coating is within the above range, such that the separator has good puncture resistance and also has a good storage capacity to retain the electrolyte solution and the performance in being infiltrated by the electrolyte solution, which is conducive to improving transmission of the electrolyte solution, and in turn, conducive to improving the cycle performance of the electrochemical apparatus.

On the basis of the first aspect, in some embodiments, the bonded particles have an average diameter of 600 nm to 1000 nm. The average diameter of the bonded particles are within the above range, which is conducive to increasing the bonding force between the bonded particles and the positive electrode plate or the negative electrode plate, and also conducive to transmission of the electrolyte solution, thereby further improving the cycle performance and low-temperature performance of the electrochemical apparatus.

On the basis of the first aspect, in some embodiments, the inorganic particles in the inorganic coating have particle sizes Dv50 of 0.4 μm to 1 μm and Dv90 of 0.8 μm to 4 μm. The particle sizes Dv50 and Dv90 of the inorganic particles satisfy the above ranges, which is conducive to transmission of the electrolyte solution, and also conducive to improving the mechanical strength of the separator and improving the heat shrinkage resistance of the separator, and in turn, conducive to further improving the cycle performance of the electrochemical apparatus.

On the basis of the first aspect, in some embodiments, the bonding layer has a thickness of 0.5 μm to 2 μm. The thickness of the bonding layer being within the above appropriate range improves infiltration of the electrolyte solution along a thickness direction of the bonding layer and a plane direction that is perpendicular to the bonding layer under the condition that the electrochemical apparatus maintains a good energy density, thereby helping to improve the low-temperature performance and cycle performance of the electrochemical apparatus.

On the basis of the first aspect, in some embodiments, the bonding layer has a coating weight per unit area of 0.5 mg/5000 mm² to 3 mg/5000 mm². The coating weight per unit area of the bonding layer being within the above range maintains good bonding forces between the bonding layer and the positive and negative electrode plates as well as between the bonding layer and the inorganic coating, and is also conducive to infiltration of the electrolyte solution in the separator to improve transmission of the electrolyte solution and thus to further improve the low-temperature performance and the cycle performance of the electrochemical apparatus.

On the basis of the first aspect, in some embodiments, the inorganic coating has a thickness of d1, and the substrate layer has a thickness of d2, the separator satisfying: 0.05≤d1/d2≤1. The thickness of the inorganic coating and the thickness of the substrate layer satisfy the above relation, which satisfies the heat shrinkage resistance of the separator and is also conducive to transmission of the electrolyte solution, such that the electrochemical apparatus maintains good cycle performance and low-temperature performance.

On the basis of the first aspect, in some embodiments, the separator has a porosity of 30% to 50%. The porosity of the separator being within the above range can not only improve a solution retention capacity of the separator, but also reduce the transmission impedance of the lithium ions to improve the conductivity of the lithium ions, thereby helping to improve the cycle performance of the electrochemical apparatus.

The bonded particles are formed by swelling polymer particles, and at 60° C., a degree of swelling of the polymer particles in carboxylate after 24 h is 100% to 300%. The carboxylate includes at least one of methyl formate, ethyl formate, methyl acetate, ethyl acetate, propyl acetate, methyl propionate, ethyl propionate, or propyl propionate. The protrusions on the surfaces of the bonded particles may be formed by part of the polymer particles swelling in the electrolyte solution and protruding from the surface. The degree of swelling of the polymer particles are within the above range, such that the bonding layer has a good bonding force and is also conducive to transmission of the electrolyte solution. Moreover, pore plugging of the substrate layer can further be reduced, which is conducive to further improving the cycle performance and low-temperature performance of the electrochemical apparatus.

A second aspect of this application provides an electrochemical apparatus, including an electrode assembly. The electrode assembly includes a positive electrode plate, a negative electrode plate and the separator. The separator is located between the positive electrode plate and the negative electrode plate. The above separator is conducive to improving the cycle performance and low-temperature performance of the electrochemical apparatus.

A third aspect of this application provides an electronic apparatus. The electronic apparatus includes the electrochemical apparatus. The electrochemical apparatus includes a separator that improves the cycle performance and low-temperature performance of the electrochemical apparatus, thereby helping to prolong the service life of the electrochemical apparatus.

### BRIEF DESCRIPTION OF DRAWINGS

The foregoing and/or additional aspects and advantages of this application will become apparent and readily understood from the description of the embodiments in conjunction with the following accompanying drawings.

FIG. 1 is a scanning electron microscope image of a separator provided in Embodiment 1 of this application.

FIG. 2 is an enlarged scanning electron microscope image of an area A in FIG. 1.

### DETAILED DESCRIPTION

The technical solutions in the embodiments of this application are described clearly in detail below. Apparently, the described embodiments are some rather than all of the embodiments of this application. Unless otherwise defined, all technical and scientific terms used herein bear the same meanings as what is normally understood by a person skilled in the technical field of this application. The terms used in the specification of this application are merely for the purpose of describing specific embodiments and are not intended to limit this application.

As used herein, quantities, ratios, and other values are sometimes presented herein in a range format. Understandably, such a range format is set out for convenience and brevity, and needs to be flexibly understood to include not only the numerical values explicitly specified and defined by the range, but also all individual numerical values or sub-ranges covered in the range as if each individual numerical value and each sub-range were explicitly specified.

This application provides a separator, including a substrate layer, an inorganic coating, and a bonding layer. The inorganic coating is disposed between the substrate layer and the bonding layer. The bonding layer contains a plurality of bonded particles. A surface of each bonded particle contains a plurality of protrusions, an average diameter of the protrusions ranges from 20 nm to 100 nm.

According to the separator in this application, the surface of each bonded particle contains a plurality of protrusions, the formation of the protrusions increases contact sites between the bonding layer and a positive electrode plate or a negative electrode plate, which is conducive to increasing interface bonding forces between the bonding layer and electrode plates. Moreover, the protrusions can further be embedded in a positive active material layer or a negative active material layer to further increase the bonding forces between the bonding layer and the electrode plates, thereby helping to improve the cycle performance and energy density of the electrochemical apparatus. Each bonded particle contains a plurality of protrusions. The arrangement of the protrusions increases the volume of the bonded particle, which is conducive to improving the capacity of the separator to retain an electrolyte solution, and in turn, conducive to improving conduction of lithium ions as well as improving the cycle performance and low-temperature performance of the electrochemical apparatus. Moreover, the average diameter of the protrusions is within the above range, such that the protrusions can come into full contact with the active material layers in the electrode plates to maintain good bonding forces. Moreover, it is also conducive to improving transmission of the electrolyte solution between the bonding layer and the active material layers in the electrode plates, and in turn, conducive to improving conduction of active ions, thereby improving the cycle performance, low-temperature performance and rate performance of the electrochemical apparatus.

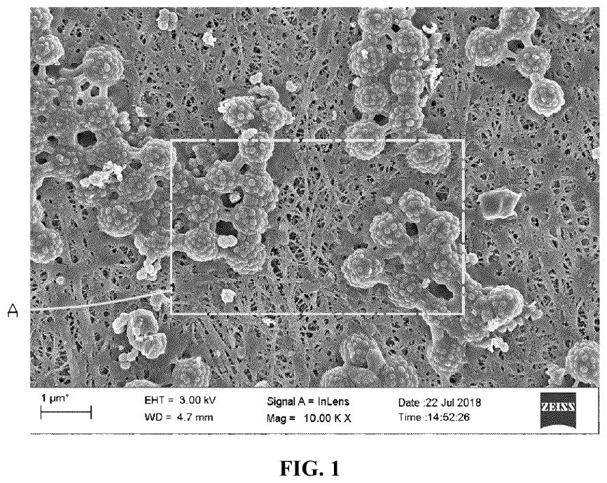

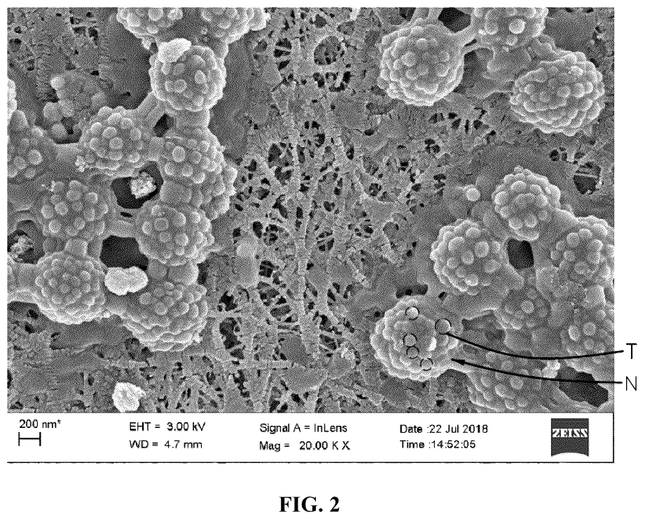

Referring to FIG. 1 and FIG. 2, a plurality of bonded particles N are formed on a surface of the separator. The bonded particles N are protrusively disposed on the surface of the separator. A plurality of protrusions T are further formed on the surface of each bonded particle N, that is, positions indicated by the dashed circles in FIG. 2. The plurality of protrusions T are formed and overlay the entire surface of the bonded particle N.

If the average diameter of the protrusions T is relatively small, e.g., less than 20 nm, contact areas between the protrusions T and the positive electrode plate or the negative electrode plate can be reduced, and bonding forces between the bonding layer and the electrode plates are reduced. Moreover, when the average diameter of the protrusions Tis overly small, the number of the protrusions T is indirectly increased, thereby affecting the transmission of the electrolyte solution in the plane direction that is perpendicular to the bonding layer, and in turn, affecting the cycle performance and low-temperature performance of the electrochemical apparatus. If the average diameter of the protrusions T is relatively large, e.g., greater than 100 nm, contact sites with the positive electrode plate or negative electrode plate will be reduced, thereby affecting the interface bonding force between the bonding layer and the positive electrode plate or the negative electrode plate. In some embodiments, the average diameter of the protrusions T may be 20 nm, 30 nm, 40 nm, 50 nm, 60 nm, 70 nm, 80 nm, 90 nm, 100 nm, or a value falling within a range formed by any two thereof.

In some embodiments, the average diameter of the protrusions may be 40 nm to 100 nm. Even further, the average diameter of the protrusions may be 40 nm to 80 nm, which can further improve the cycle performance, low-temperature performance and rate performance of the electrochemical apparatus.

In some embodiments, part of the adjacent bonded particles are connected to each other, and the number of the connected bonded particles accounts for more than 50% of the total number of the bonded particles. Part of the adjacent bonded particles are connected to form a mesh structure, which can increase the interface bonding force between the positive electrode plate and the negative electrode plate when the bonded particles are bonded to the positive electrode plate or the negative electrode plate, thereby helping to improve the cycle performance of the electrochemical apparatus. In some embodiments, the number of the connected bonded particles accounts for 50%, 60%, 70%, 80%, 90%, 95%, or a value falling within a range formed by any two thereof of the total number of the bonded particles.

In some embodiments, the number of the connected bonded particles accounts for 50% to 100% of the total number of the bonded particles.

In some embodiments, an absorption peak of —COOH is presented at 1680 cm⁻¹ to 1750 cm⁻¹ in an infrared spectrum of the bonding layer, and transmittance of the absorption peak is 50% to 95%. The carboxyl absorption peak is presented in the bonding layer, and carboxyl has polarity, which is conducive to improving the performance of the electrolyte solution in infiltrating the separator and also conducive to increasing a bonding force of the bonding layer. The transmittance of the absorption peak is within the above range, such that the bonding layer contains an appropriate number of protrusions, which enables the bonding layer to have a good bonding force and is also conducive to improving the performance of the electrolyte solution in infiltrating the separator, thereby improving the cycle performance and rate performance of the electrochemical apparatus. If the transmittance of the absorption peak is relatively small, e.g., less than 50%, the bonding layer contains a relatively large number of protrusions, which may affect the transmission of the electrolyte solution, and in turn, affects the cycle performance and rate performance of the electrochemical apparatus. If the transmittance of the absorption peak is relatively large, e.g., greater than 95%, the bonding layer contains a relatively small number of protrusions, which reduces the bonding force of the bonding layer, and in turn, affects the cycle performance of the electrochemical apparatus. In some embodiments, the transmittance of the absorption peak of —COOH may be 50%, 60%, 70%, 80%, 90%, 95%, or a value falling within a range formed by any two thereof.

In some embodiments, in a scanning electron microscope image of the separator at a magnification of 10⁴, within an area of 11.6 μm×7.6 μm, the number of the bonded particles is 10 to 60. The number of the bonded particles is within the above range, such that the bonding layer has a good bonding force, and it is also conducive to improving the performance of the electrolyte solution in infiltrating the separator, thereby improving the cycle performance and rate performance of the electrochemical apparatus. If the number of the bonded particles is relatively small, bonding forces between the bonding layer and the positive electrode plate as well as between the bonding layer and the negative electrode plate are reduced. If there are a relatively large number of bonded particles, the rate performance and low-temperature performance of the electrochemical apparatus may be reduced. In some embodiments, the number of the bonded particles is 10, 15, 20, 25, 30, 35, 40, 45, 50, 55, 60, or a value falling within a range formed by any two thereof.

In some embodiments, each bonded particle contains 5 to 50 protrusions. When it is satisfied that the number of protrusions on the surface of the bonding layer is appropriate within the above area, contact sites between the bonded particles and the positive and negative electrode plates are increased, and the bonding forces between the bonded particles and the positive and negative electrode plates are increased. Being within the above range of number of the protrusions is more conducive to embedding the bonded particles into an active material layer of the positive electrode plate or the negative electrode plate, thereby further improving a bonding force between the bonded particles and the positive electrode plate or the negative electrode plate, and in turn, helping to improve the cycle performance and energy density of the electrochemical apparatus. Moreover, being within the above range of number of the protrusions is also more conducive to improving the capacity of the separator to retain the electrolyte solution, thereby helping to improve conduction of the lithium ions and improve the cycle performance and kinetic performance of the electrochemical apparatus. In some embodiments, within the area of 11.6 μm×7.6 μm, the number of the protrusions may be 5, 8, 10, 12, 14, 16, 18, 20, 24, 28, 30, 32, 34, 38, 40, 44, 48, 50, or a value falling within a range formed by any two thereof.

In some embodiments, the inorganic coating includes inorganic particles and a binder. The inorganic particles include at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide, or barium sulfate. The above inorganic particles can improve the mechanical strength of the separator and are also conducive to improving the effect of the electrolyte solution in infiltrating the separator and improving the cycle performance of the electrochemical apparatus.

The binder includes at least one of acrylic acid, methyl methacrylate, butyl acrylate, octyl acrylate, isooctyl acrylate, butadiene, or acrylonitrile. The above binder is conducive to increasing a bonding force between the inorganic particles in the inorganic coating and a bonding force between the inorganic coating and the substrate layer and to increasing an interface bonding force between the inorganic coating and the substrate layer, which is conducive to transmission of lithium ions, thereby improving the cycle performance of the electrochemical apparatus. Based on the mass of the inorganic coating, a mass percent of the inorganic particles is 85% to 95%. The mass percent of the inorganic particles being within the above range enables the electrochemical apparatus to have improved thermal safety on the basis of having good kinetic performance. In some embodiments, based on the mass of the inorganic coating, the mass percent of the inorganic particles may be 85%, 87%, 89%, 90%, 92%, 93%, 94%, 95%, or a value falling within a range formed by any two thereof.

Based on a mass of the inorganic coating, a mass percent of the binder is 5% to 15%. The mass percent of the binder is within the above range, such that the inorganic coating and the substrate layer have a good bonding force therebetween. In some embodiments, based on the mass of the inorganic coating, the mass percent of the binder may be 5%, 7%, 8%, 9%, 10%, 12%, 13%, 14%, 15%, or a value falling within a range formed by any two thereof.

In some embodiments, the bonded particles are formed by polymerization of at least two monomers selected from: butadiene, methyl acrylate, methyl methacrylate, styrene, butyl methacrylate, isooctyl acrylate, ethylene, propylene, or vinylidene fluoride. The bonded particles formed by polymerization of the above monomers have a good bonding force and the performance of the electrolyte solution in infiltrating the bonding layer, such that the bonding layer can provide a certain bonding force.

The bonded particles further include at least one of acrylic acid, acrylonitrile, or butadiene. The addition of the above substances can further increase a bonding force between the bonding layer and the inorganic coating, such that the bonding layer has a good bonding force, which is conducive to improving the cycle performance of the electrochemical apparatus.

In some embodiments, the inorganic coating has a thickness of 0.5 μm to 5 μm. The thickness of the inorganic coating is within the above range, such that the separator has good puncture resistance and also has a good storage capacity to retain the electrolyte solution and the performance in being infiltrated by the electrolyte solution, which is conducive to improving transmission of the electrolyte solution, and in turn, conducive to improving the cycle performance of the electrochemical apparatus. In some embodiments, the thickness of the inorganic coating may be 0.5 μm, 0.8 μm, 1 μm, 1.5 μm, 1.8 μm, 2 μm, 2.5 μm, 3 μm, 3.5 μm, 4 μm, 4.5 μm, 5 μm, or a value falling within a range formed by any two thereof.

In some embodiments, the bonded particles have an average diameter of 600 nm to 1000 nm. The average diameter of the bonded particles are within the above range, which is conducive to increasing a bonding force between the bonded particles and the positive electrode plate or the negative electrode plate, and also conducive to the transmission of the electrolyte solution, thereby further improving the cycle performance and low-temperature performance of the electrochemical apparatus. If the average diameter of the bonded particles is relatively small, e.g., less than 600 nm, the bonded particles contain a relatively small number of protrusions, which is not conducive to increasing the bonding force of the bonding layer. If the average diameter of the bonded particles is relatively large, e.g., greater than 1000 nm, the transmission of the electrolyte solution is affected, which is not conducive to improving the low-temperature performance of the electrochemical apparatus. In some embodiments, the average diameter of the bonded particles is 600 nm, 650 nm, 700 nm, 800 nm, 850 nm, 900 nm, 950 nm, 1000 nm, or a value falling within a range formed by any two thereof.

In some embodiments, the inorganic particles in the inorganic coating have particle sizes Dv10 of 0.2 μm to 0.6 μm, Dv50 of 0.4 μm to 1 μm, and Dv90 of 0.8 μm to 4 μm. The particle sizes Dv10, Dv50 and Dv90 of the inorganic particles satisfy the above ranges, which is conducive to the transmission of the electrolyte solution, and also conducive to improving the mechanical strength of the separator and improving the heat shrinkage resistance of the separator, and in turn, conducive to further improving the cycle performance of the electrochemical apparatus. In some embodiments, the particle size Dv10 of the inorganic particles may be 0.2 μm, 0.3 μm, 0.4 μm, 0.5 μm, 0.6 μm, or a value falling within a range formed by any two thereof. The particle size Dv50 of the inorganic particles may be 0.4 μm, 0.5 μm, 0.6 μm, 0.7 μm, 0.8 μm, 0.9 μm, 1 μm, or a value falling within a range formed by any two thereof. The particle size Dv90 of the inorganic particles may be 0.8 μm, 1 μm, 1.2 μm, 1.5 μm, 1.8 μm, 2.3 μm, 2.7 μm, 3.2 μm, 3.7 μm, 4 μm, or a value falling within a range formed by any two thereof.

In some embodiments, the bonding layer has a thickness of 0.5 μm to 2 μm. The thickness of the bonding layer being within the above appropriate range improves infiltration of the electrolyte solution along a thickness direction of the bonding layer and a plane direction that is perpendicular to the bonding layer under the condition that the electrochemical apparatus maintains a good energy density, thereby helping to improve the low-temperature performance and cycle performance of the electrochemical apparatus. In some embodiments, the thickness of the bonding layer may be 0.5 μm, 0.8 μm, 1 μm, 1.2 μm, 1.5 μm, 1.8 μm, 2 μm, or a value falling within a range formed by any two thereof.

In some embodiments, the bonding layer has a coating weight per unit area of 0.5 mg/5000 mm² to 3 mg/5000 mm². The coating weight per unit area of the bonding layer being within the above range maintains good bonding forces between the bonding layer and the positive and negative electrode plates as well as between the bonding layer and the inorganic coating, and is also conducive to infiltration of the electrolyte solution in the bonding layer to improve the transmission of the electrolyte solution and thus to further improve the low-temperature performance and cycle performance of the electrochemical apparatus. In some embodiments, the coating weight per unit area of the bonding layer is 0.5 mg/5000 mm², 1 mg/5000 mm², 1.5 mg/5000 mm², 2 mg/5000 mm², 2.5 mg/5000 mm², 3 mg/5000 mm², or a value falling within a range formed by any two thereof.

In some embodiments, the inorganic coating has a thickness of d1, and the substrate layer has a thickness of d2, the separator satisfying: 0.05≤d1/d2≤1. The thickness of the inorganic coating and the thickness of the substrate layer satisfy the above relation, which satisfies the heat shrinkage resistance of the separator and is also conducive to improving the transmission of the electrolyte solution, such that the electrochemical apparatus maintains good cycle performance and low-temperature performance. In some embodiments, a ratio of d1/d2 may be 0.05, 0.1, 0.2, 0.3, 0.5, 0.8, 1, or a value falling within a range formed by any two thereof.

In some embodiments, the separator has a porosity of 30% to 50%. The porosity of the separator being within the above range can not only improve a solution retention capacity of the separator, but also reduce the transmission impedance of the lithium ions to improve the conductivity of the lithium ions, thereby helping to improve the cycle performance of the electrochemical apparatus. In some embodiments, the porosity of the separator may be 30%, 32%, 35%, 38%, 40%, 42%, 45%, 48%, 50%, or a value falling within a range formed by any two thereof. Preferably, the porosity of the separator is 35% to 45%.

The bonded particles are formed by swelling polymer particles, and at 60° C., a degree of swelling of the polymer particles in carboxylate after 24 h is 100% to 300%. The carboxylate includes at least one of methyl formate, ethyl formate, methyl acetate, ethyl acetate, propyl acetate, methyl propionate, ethyl propionate, or propyl propionate. The protrusions on the surfaces of the bonded particles may be formed by part of the polymer particles swelling in the electrolyte solution and protruding from the surface. The degree of swelling of the polymer particles are within the above range, such that the bonding layer has a good bonding force and is also conducive to transmission of the electrolyte solution. Moreover, pore plugging of the substrate layer can further be reduced, which is conducive to further improving the cycle performance and low-temperature performance of the electrochemical apparatus. In some embodiments, the degree of swelling of the polymer particles in the carboxylate after 24 h may be 100%, 120%, 150%, 200%, 220%, 250%, 300%, or a value falling within a range formed by any two thereof.

In some embodiments, the separator includes two bonding layers. One of the bonding layers is located on a surface of the inorganic coating back away from the substrate layer, and the other one of the bonding layers is located on a surface of the substrate layer back away from the inorganic coating. The bonding layer containing the inorganic coating is close to the positive electrode plate. The inorganic coating can resist the damage to the separator caused by crystal precipitation on the positive electrode plate and improve the safety of the electrochemical apparatus. The two sides of the separator contain bonding layers, thereby increasing the bonding forces between the separator and the positive electrode plate as well as between the separator and the negative electrode plate and reducing the possibility of deformation of the electrochemical apparatus during the cycling process, and improving the cycle performance of the electrochemical apparatus.

In this application, the types of the monomers selected for the bonded particles, the content of acrylates, the content of linear esters in the electrolyte solution, and the soaking time and temperature of the polymer particles all affect the average diameter of the protrusions on the surfaces of the bonded particles. If the content of the acrylates during polymerization of the monomers is greater, or the content of the linear esters in the electrolyte solution is greater, the average diameter of the protrusions is increased. The higher or/and longer the temperature or/and time the polymer particles are soaked in an electrolyte solution containing carboxylate, the larger the average diameter of the protrusions is. The appropriate soaking time of the separator in the electrolyte solution may be 8 h to 24 h, and the soaking temperature may be 60° C. to 80° C.

The number of the bonded particles in the bonding layer, the average diameter, and the number of the protrusions are all affected by the elements of the coating weight per unit area of the bonding layer, synthesis process steps, the degree of swelling of the polymer particles, and the types of the monomers selected for polymerization for the bonded particles.

The ratio of the number of the connected bonded particles is affected by the conditions of the coating weight per unit area, the types of the monomers selected for the bonded particles, the average diameter of the bonded particles, and the degree of swelling.

In this application, the thicknesses of both the bonding layer and the inorganic coating may be adjusted and controlled by changing the size of the average diameter of the bonded particles, the size of the particle size of the inorganic particles, and the coating weight per unit area. The particle size of the inorganic particles may be adjusted and controlled by adjusting and controlling the stirring time and the stirring rate.

An embodiment of this application further provides an electrochemical apparatus, including a shell, an electrode assembly and an electrolyte solution. A battery cell and the electrolyte solution are located within the shell. The shell may be a packaging bag obtained by encapsulation using an encapsulation film, such as an aluminum-plastic film. For example, the electrochemical apparatus is a pouch secondary battery. In other embodiments, the electrochemical apparatus may also be a steel-shell battery, an aluminum-shell battery, or the like.

The electrode assembly includes a positive electrode plate, a negative electrode plate and a separator. The separator is located between the positive electrode plate and the negative electrode plate. The electrode assembly may be of a stacked structure which is formed by stacking the positive electrode plate, the separator and the negative electrode plate. In other embodiments, the electrode assembly may also be of a jelly-roll structure which is formed by stacking and then winding the positive electrode plate, the separator and the negative electrode plate.

### Positive Electrode Plate

A positive electrode plate includes a positive current collector and a positive active layer disposed on the positive current collector. The positive current collector may use aluminum foil, nickel foil, or the like, and may also be a composite current collector disclosed in the prior art, for example but not limited to a current collector formed by combining the foregoing conductive foil with a polymer substrate. The positive active layer includes a positive active material. The positive active material includes a compound that enables reversible intercalation and deintercalation of lithium ions, i.e., a lithiated intercalation compound. In some embodiments, the positive active material may include a lithium transition metal composite oxide. The lithium transition metal composite oxide contains lithium and at least one element selected from cobalt, manganese, or nickel. In some embodiments, the positive active material may include, but is not limited to, at least one of lithium cobalt oxide, lithium nickel cobalt manganese oxide, lithium nickel manganese aluminum oxide, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel lithium manganese oxide, spinel lithium nickel manganese oxide, or lithium titanium oxide.

The positive active layer further includes a binder for bonding positive active material particles so as to form a film layer, and a bonding force between the positive active layer and the positive current collector can also be increased. In some embodiments, the binder may include, but is not limited to, at least one of polyvinyl alcohol, hydroxypropyl cellulose, diacetyl cellulose, polyvinyl chloride, carboxylated polyvinyl chloride, polyvinyl fluoride, a polymer containing ethylidene oxygen, polyvinylpyrrolidone, polyurethane, polytetrafluoroethylene, poly(1,1-difluoroethylene), polyethylene, polypropylene, styrene-butadiene rubber, acrylic styrene-butadiene rubber, epoxy resin, nylon, or the like.

The positive active layer may further include a conductive material. The conductive material includes, but is not limited to, a carbon-based material, a metal-based material, a conductive polymer, or any combination thereof. In some embodiments, the carbon-based material may include, but is not limited to, natural graphite, artificial graphite, carbon black, acetylene black, Ketjen black, carbon fibers, or any combination thereof. In some embodiments, the metal-based material may include, but is not limited to, metal powders, or metal fibers, such as copper, nickel, aluminum, or silver. In some embodiments, the conductive polymer may be a polyphenylene derivative.

### Separator

The material and the shape of the separator used in the electrochemical apparatus according to this application are not particularly limited, and may be based on any technology disclosed in the prior art. In some embodiments, the separator includes a polymer or an inorganic substance or the like made of a material that is stable to the electrolyte solution of this application. In this application, the separator described above is used.

For example, the substrate layer is a non-woven fabric, film or composite film, which, in each case, is of a porous structure. The material of the substrate layer is at least one selected from polyethylene, polypropylene, polyethylene terephthalate, or polyimide. Specifically, the material of the substrate layer may be a polypropylene porous film, a polyethylene porous film, a polypropylene non-woven fabric, a polyethylene non-woven fabric, or a polypropylene-polyethylene-polypropylene porous composite film.

### Electrolyte Solution

According to some embodiments of this application, the electrolyte solution includes an organic solvent, a lithium salt, and optionally an additive.

The organic solvent in the electrolyte solution of this application may be any organic solvent known in the prior art suitable for use as a solvent of the electrolyte solution. An electrolyte used in the electrolyte solution according to this application is not limited and may be any electrolyte known in the prior art. The additive of the electrolyte solution according to this application may be any additive known in the prior art suitable for use as an additive of the electrolyte solution. In some embodiments, the organic solvent includes, but is not limited to: ethylene carbonate (EC), propylene carbonate (PC), diethyl carbonate (DEC), ethyl methyl carbonate (EMC), dimethyl carbonate (DMC), or ethyl propionate.

In some embodiments, the organic solvent includes an ether solvent, such as at least one of 1,3-dioxane (DOL) or ethylene glycol dimethyl ether (DME). In some embodiments, the lithium salt includes at least one of an organic lithium salt or an inorganic lithium salt. In some embodiments, the lithium salt includes, but is not limited to: lithium hexafluorophosphate (LiPF₆), lithium tetrafluoroborate (LiBF₄), lithium difluorophosphate (LiPO₂F₂), lithium bistrifluoromethanesulfonimide LiN(CF₃SO₂)₂ (LiTFSI), lithium bis(fluorosulfonyl)imide Li(N(SO₂F)₂) (LiFSI), lithium bis(oxalate) borate LiB(C₂O₄)₂ (LiBOB), or lithium difluoro (oxalate) borate LiBF₂(C₂O₄) (LiDFOB). In some embodiments, the additive includes at least one of fluoroethylene carbonate or adiponitrile.

According to some embodiments of this application, the electrochemical apparatus in this application includes, but is not limited to: a lithium-ion battery.

According to this application, the electrochemical apparatus is further used in an electronic apparatus. The electrochemical apparatus supplies power to a load of the electronic apparatus. In the above electronic apparatus, the electrochemical apparatus has good low-temperature performance and cycle performance, thereby helping to improve the service life and low-temperature universality of the electronic apparatus.

The electronic apparatus may include, but is not limited to, a notebook computer, a pen-input computer, a mobile computer, an electronic book player, a portable phone, a portable fax machine, a portable copier, a portable printer, a stereo headset, a video recorder, a liquid crystal television, a hand-held cleaner, a portable CD machine, a mini disc, a transceiver, an electronic organizer, a calculator, a memory card, a portable audio recorder, a radio, a backup power supply, a motor, an automobile, a motorcycle, a power bicycle, a bicycle, a lighting appliance, a toy, a game machine, a clock, a power tool, a flash light, a camera, a large household storage battery, a lithium-ion capacitor, and the like.

The following further describes this application with reference to specific embodiments and comparative embodiments. A person skilled in the art should understand that a preparation method described in this application is only an embodiment, and any other suitable preparation methods are within the scope of this application.

### Embodiment 1

### <Preparing a Battery Separator>

Mixing boehmite as inorganic particles with Dv50 of 1 μm with polyacrylate at a mass ratio of 90:10 and then dissolving the mixture into deionized water to form an inorganic coating slurry in which the solid content is 50%, subsequently, using a microgravure coating method to uniformly coat one surface of a substrate layer made of polyethylene (PE) with the obtained inorganic coating slurry, and completing drying in an oven to obtain an inorganic ceramic coating, where the inorganic particles have particle sizes Dv10 of 0.84 μm, Dv50 of 1.09 μm and Dv90 of 1.91 μm. The inorganic coating has a thickness of 2 μm.

Adding 90 g of polymer particles into a stirrer, where a weight-average molecular weight of the polymer particles is 600,000, and polymer monomers including in percent by mass: 5% of methyl acrylate, 78% of styrene, 2% of butadiene and 15% of isobutyl acrylate; then adding 10 g of sodium carboxymethyl cellulose, stirring the mixture well, adding 5 g of dimethylsiloxane as a wetting agent, then adding deionized water for stirring, and adjusting the viscosity of a slurry to be 2000 mPa's to 5000 mPa's and a solid content to be 5% to obtain a bonding layer slurry. Subsequently, using a silk-screen printing coating method to uniformly coat surfaces of the inorganic ceramic coating and the substrate layer with the above bonding layer slurry, respectively, with a coating weight of 1 mg/5000 mm², and subsequently, completing drying in the oven to form a bonding layer, thereby obtaining a separator, where the bonded particles in the bonding layer have an average diameter of 0.6 μm, and the separator has a porosity of 42.5%.

### <Preparing a Negative Electrode Plate>

Mixing artificial graphite as a negative active material, acetylene black, styrene-butadiene rubber and sodium carboxymethyl cellulose at a mass ratio of 96:1:1.5:1.5, then adding deionized water as a solvent to formulate a negative electrode slurry in which the solid content is 70%, and subsequently, stirring well with a vacuum mixer. Uniformly coating a surface of 8-μm thick copper foil with the negative electrode slurry, drying the same at 110° C., and performing cold-calendering to obtain a negative electrode plate with one side coated with a 150-μm negative active material layer. Performing the above coating steps again on the other side of the negative electrode plate to obtain a negative electrode plate with both sides coated with negative active material layers. Cutting the negative electrode plate into a size of 74 mm×867 mm and welding a tab to the negative electrode plate for use.

### <Preparing a Positive Electrode Plate>

Mixing lithium cobalt oxide as a positive active material, acetylene black and polyvinylidene difluoride (PVDF) at a mass ratio of 94:3:3, then adding N-methyl-pyrrolidone (NMP) as a solvent to formulate a positive electrode slurry in which the solid content is 75%, and subsequently, stirring well with a vacuum mixer. Uniformly coating a surface of 12-μm aluminum foil with the positive electrode slurry, drying the same at 90° C., and performing cold-calendering to obtain a positive electrode plate with one side coated with a 100-μm thick positive active material layer. Performing the above coating steps again on the other side of the positive electrode plate to obtain a positive electrode plate with both sides coated with negative active material layers. Cutting the positive electrode plate into a size of 74 mm×867 mm, and welding a tab onto the positive electrode plate for use.

### <Preparing an Electrolyte Solution>

Mixing ethylene carbonate (EC), diethyl carbonate (DEC), propylene carbonate (PC), propyl propionate (PP) and vinylene carbonate (VC) as a nonaqueous organic solvent at a mass ratio of 20:30:20:28:2 in an environment in which the moisture content is less than 10 ppm, and then adding lithium hexafluorophosphate (LiPF₆) into the nonaqueous organic solvent for dissolving and stirring well to obtain an electrolyte solution. Based on a total mass of the electrolyte solution, a mass content of LiPF₆ is 8%.

### <Preparing a Secondary Battery>

Stacking the above-prepared positive electrode plate, battery separator and negative electrode plate in sequence in such a way that the separator is located between the positive electrode plate and the negative electrode plate to serve a function of separation, where the surface of the separator containing the inorganic ceramic coating directly faces the positive electrode plate and comes into contact with the positive electrode plate, the negative electrode plate comes into contact with another bonding layer, and a tab of a positive electrode is located on an extension line of at least part of a linear binder, and winding the stacked structure to obtain an electrode assembly. Putting the electrode assembly into an aluminum-plastic film packaging bag, dehydrating the electrode assembly at 80° C., and then injecting the prepared electrolyte solution. Performing steps such as vacuum sealing, standing, chemical formation, and shaping to obtain a secondary battery. At 60° C., the degree of swelling of the polymer particles in the electrolyte solution after 24 h is 150%.

### Performance Test Method:

### (1) Average Diameter of Bonded Particles

In a scanning electron microscope of the separator, by statistically analyzing a particle size of bonded particles within an area of 11.6 μm×7.6 μm with an image statistics method, and based on a particle size of a single particle, excluding secondary particles formed by a plurality of particles, where polymers are spherical or spheroidal, arbitrarily selecting 32 particles for testing, and calculating an average value thereof, i.e., an average diameter of the bonded particles.

### (2) Number of Bonded Particles

In a scanning electron microscope of the separator, at a magnification of 10⁴, by statistically analyzing the number of bonded particles within an area of 11.6 μm×7.6 μm with the image statistics method, and based on a particle size of a single particle, excluding secondary particles formed by a plurality of particles, where polymers are spherical or spheroidal, and by statistically analyzing data of 32 bonded particles within the above area of the separator, calculating an average value, i.e., the number of the bonded particles.

### (3) Average Diameter of Protrusions

In a scanning electron microscope of the separator, by statistically analyzing the number of bonded particles within an area of 11.6 μm×7.6 μm with the image statistics method, and based on a particle size of a single particle of the bonded particles, excluding secondary particles formed by a plurality of particles, and by testing the diameter of particle protrusions on 32 bonded particles, calculating an average value, i.e., the average diameter of the protrusions.

### (4) Number of Protrusions

In a scanning electron microscope of the separator, by statistically analyzing the number of protrusions of the bonded particles within an area of 11.6 μm×7.6 μm with the image statistics method, and based on a particle size of a single particle of the bonded particles, excluding secondary particles formed by a plurality of particles, and counting the number of particle protrusions on 32 bonded particles, calculating an average value, i.e., the number of the protrusions.

### (5) Particle Sizes Dv10, Dv50 and Dv90 of Inorganic Particles

Performing measurement by using a laser particle size analyzer Malvern 3000, adding 50 ml of water into a beaker, adding about 2 g of a material (inorganic particles), and stirring a solution to fully disperse the material. After completing cleaning of a device, adding more than two-thirds of DI water, and debugging a rotating speed to 2800±50. Clicking “Initialize Instrument” and waiting for the instrument to complete initialization, clicking “Measure Background”, which requires a laser intensity to be higher than 70% and a background light intensity to be lower than 100. After completing a background test, adding a test sample, when a laser shade degree reaches a specified range of 10-12%, waiting for 5-8 S, clicking “Test Sample”, after completing the test, automatically generating a numerical value, and recording three sets of test data Dv10, Dv50, and Dv90. Setting device parameters: the refractive index is 1.765, the absorptivity is 0.1, and the density is 1.05.

### (6) Thicknesses of Bonding Layer, Inorganic Coating, and Separator

Performing testing with a VL 50 ten-thousandth micrometer, specifically, pressing a “▾” button to make a measuring head fit closely with a test platform, and pressing a “zero” button to reset a thickness gauge to zero. Pressing a “▴” button to raise the measuring head, and picking up the separator to lay the same flat on the test platform, such that the separator at a measuring position remains flat on the test platform and the measuring position is aligned with the measuring head. Pressing the “▾” button until the measuring head is stationary. When data remains stable and constant, recording the data in a table; Transversely and uniformly measuring 16 points at intervals of about 1 point every 20 mm; uniformly measuring 16 points in width, and then calculating an average value of the 32 points measured in the transverse direction and width direction. Similarly, the bonding layer and the inorganic coating use the same measuring method.

### (7) Coating Weight Per Unit Area of Bonding Layer

Die-cutting samples before and after the substrate layer is coated with the bonding layer into long pieces of 50*100 mm in size, measuring weights by using an electronic balance with an accuracy of 4 decimal places, and recording the weights as m1 and m2. Taking 6 measuring points before and after coating to calculate an average value, and calculating to obtain a coating weight per unit area.

### (8) Porosity of Separator

Cutting separator samples into discs with a diameter of 10 mm, and putting the die-cut separator samples into a sample cup. Putting the separator sample cup into a sample compartment, closing the sample compartment, and performing testing by using a true density meter gas exchange method. Recording a test result, testing each separator sample for three times, and calculating an average value.

### (9) Testing Absorption Peak of —COOH

Taking out 1-2 mg of a sample into a agate mortar, and adding 150 mg of a potassium bromide powder to be fully ground. Putting the ground powder into a mold, and pressing the same into a tablet with a tablet press. Putting the pressed sample tablet into a sample compartment, using an infrared device to perform testing with a wave number of 400-4000 cm⁻¹. Test results are used to develop a graph with the wave number cm⁻¹ as the abscissa and the absorbance % as the ordinate. The absorption peak of —COOH is presented at an interval of wave number of 1680-1750 cm⁻¹.

### (10) Testing Degree of Swelling

Cutting the prepared separator into small pieces of about 2 g by using scissors, and making 3 parallel samples for each type of separator. Respectively weighing the small pieces of separator, recording initial weight as M1, putting the small pieces of separator into small bottles, identifying sample names, adding a testing electrolyte solution, that is, the above electrolyte solution in the lithium-ion battery, that exceeds adhesive films by 3 cm, sealing the small bottles, and putting the same into the oven to bake at 60° C. for 24 h. Taking out the separators, wiping up the same with dust-free paper, and recording the weight of each separator as M2.

$$Degree of swelling = ( M 2 - M 1 ) / M 1 \times 100 \% , and calculating an average value of degrees of swelling of the 3 parallel samples as a final degree of swelling .$$

### Performance Test of Lithium-Ion Battery

### Testing Bonding Force Between Separator and Electrode Plate:

Testing a bonding force between the separator and the positive electrode plate or the negative electrode plate by using the national standard GB/T 2790-1995, i.e., using the 180-degree peel test standard, cutting the separator and the positive electrode plate or the negative electrode plate into samples of 54.2 mm×72.5 mm in size, compositing the separator and the positive electrode plate or the negative electrode plate, hot-pressing the composited structure by using a hot press with hot-pressing conditions of temperature of 85° C., pressure of 1 MPa and hot-pressing time of 85 s (seconds), cutting a composited sample into small pieces of 15 mm×54.2 mm in size, and testing the bonding force between the separator and the positive electrode plate or the negative electrode plate according to the 180-degree peel test standard.

### Testing Low-Temperature Capacity Retention Rate:

At 25° C., charging the lithium-ion battery at a constant current of 0.5 C until the voltage reaches 4.53 V, charging the lithium-ion battery at a constant voltage until the current reaches 0.02 C, then discharging the lithium-ion battery at a constant current of 0.2 C until the voltage reaches 2.5 V, and recording a discharge capacity of the lithium-ion battery at 25° C. at this time. Then charging the lithium-ion battery at a constant current of 0.5 C until the voltage reaches 4.53 V, charging the lithium-ion battery at a constant voltage until the current reaches 0.02 C, then putting the lithium-ion battery at a temperature of −20° C., charging the lithium-ion battery at a constant current of 0.2 C until the voltage reaches 2.5 V, and recording a discharge capacity of the lithium-ion battery at −20° C. at this time. Calculating a capacity retention rate of the lithium-ion battery at −20° C., low-temperature capacity retention rate=(final discharge capacity of secondary battery at −20° C./first-cycle discharge capacity of secondary battery at 25° C.)×100%.

### Testing the Cycle Performance:

At 25° C., charging the lithium-ion battery at a constant current of 3 C until the voltage reaches 4.35 V, charging the lithium-ion battery at a constant voltage until the current reaches 1.8 C, and then discharging the lithium-ion battery at 0.7 C until the voltage reaches 3.0 V to complete one cycle, which is denoted as a first cycle. Then repeating the above steps for 800 cycles, and calculating a 800th-cycle capacity retention rate. 800th-cycle capacity retention rate=(800th-cycle discharge capacity/first-cycle discharge capacity)×100%.

### Testing Rate Performance:

At 25° C., charging the lithium-ion battery at a constant current of 0.5 C until the voltage reaches 4.47 V, charging the lithium-ion battery at a constant voltage until the current reaches 0.05 C, and sleeping for 5 min. Then discharging the lithium-ion battery at 0.2 C until the voltage reaches 3.0 V, and sleeping for 5 min. Then charging the lithium-ion battery at a constant current of 0.5 C until the voltage reaches 4.47 V, charging the lithium-ion battery at a constant voltage until the current reaches 0.05 C, and sleeping for 5 min. Then discharging the lithium-ion battery at 0.5 C until the voltage reaches 3.0 V, recording a capacity as D1, and sleeping for 5 min. Then discharging the lithium-ion battery at 2 C until the voltage reaches 3.0 V, and recording a capacity as D2. Rate performance=D2/D1*100%.

### Embodiment 0, and Embodiments 2 to 5

Identical to Embodiment 1 except the step that by changing the time of the separator in the lithium-ion battery soaked in the electrolyte solution and adjusting the average diameter of the protrusions on the separator, related parameters in Table 1 and Table 2 are obtained.

### Comparative Embodiments 1 to 3

Identical to Embodiment 1 except that by changing the types of the polymer monomers, the related parameters in Table 1 and Table 2 are obtained.

### Embodiments 6 to 12

Identical to Embodiment 1 except that by changing the temperature of the separator in the lithium-ion battery soaked in the electrolyte solution, related parameters in Table 3 are obtained.

### Embodiments 13 to 18

Identical to Embodiment 4 except that by changing the coating weight per unit area of the bonding layer, related parameters in Table 4 are obtained.

### Embodiments 19 to 23

Identical to Embodiment 1 except that by changing the thickness of the inorganic coating, related parameters in Table 5 are obtained.

### Embodiments 24 to 27

Identical to Embodiment 1 except that by changing the process of synthesizing the bonded particles and adjusting and controlling the average diameter of the bonded particles, related parameters in Table 6 are obtained.

### Embodiments 28 to 31

Identical to Embodiment 1 except that by changing the mass percent of the isobutyl acrylate in the polymer monomers and adjusting the content of the connected bonded particles, related parameters in Table 7 are obtained.

### Embodiments 32 to 33

Identical to Embodiment 1 except that by changing the porosity of the separator, related parameters in Table 8 are obtained.

### Embodiments 34 to 36

Identical to Embodiment 1 except that by changing the transmittance of the bonding layer, related parameters in Table 9 are obtained.

### Embodiments 37 to 41

Identical to Embodiment 1 except that by changing the ratio of d1/d2, related parameters in Table 10 are obtained.

### Embodiments 42 to 43

Identical to Embodiment 1 except that by changing the types and percents of the polymer monomers forming the bonded particles, related parameters in Table 11 are obtained.

TABLE 1

| | Temperature | | | |
|---|---|---|---|---|
| | of separator | Time of | | |
| | soaked in | separator | | |
| | electrolyte | soaked in | | Number of |
| | solution | electrolyte | | bonded |
| | (° C.) | solution (h) | Polymer monomers forming bonded particles | particles |
| Embodiment 0 | 70 | 8.5 | 5% of methyl acrylate, 78% of styrene, 2% of | 40 |
| | | | butadiene, and 15% of isobutyl acrylate | |
| Embodiment 1 | 70 | 10 | 5% of methyl acrylate, 78% of styrene, 2% of | 40 |
| | | | butadiene, and 15% of isobutyl acrylate | |
| Embodiment 2 | 70 | 8 | 5% of methyl acrylate, 78% of styrene, 2% of | 40 |
| | | | butadiene, and 15% of isobutyl acrylate | |
| Embodiment 3 | 70 | 9 | 5% of methyl acrylate, 78% of styrene, 2% of | 40 |
| | | | butadiene, and 15% of isobutyl acrylate | |
| Embodiment 4 | 70 | 11 | 5% of methyl acrylate, 78% of styrene, 2% of | 40 |
| | | | butadiene, and 15% of isobutyl acrylate | |
| Embodiment 5 | 70 | 12 | 5% of methyl acrylate, 78% of styrene, 2% of | 40 |
| | | | butadiene, and 15% of isobutyl acrylate | |
| Comparative | 70 | 10 | Polyvinylidene fluoride | 40 |
| Embodiment 1 | | | | |
| Comparative | 70 | 10 | 2% of methyl acrylate, 2% of butadiene, 81% | 40 |
| Embodiment 2 | | | of styrene, and 15% of isobutyl acrylate | |
| Comparative | 70 | 10 | 10% of methyl acrylate, 2% of butadiene, | 40 |
| Embodiment 3 | | | 78% of styrene, and 10% of isobutyl acrylate | |

TABLE 2

| | | Bonding force | Bonding force | | | |
|---|---|---|---|---|---|---|
| | | between | between | | Low-temperature | |
| | Average | separator | separator | 800th-cycle | capacity | |
| | diameter of | and positive | and negative | performance | retention | Rate |
| | protrusions | electrode | electrode | at 25° C. | rate at −20° | performance |
| | (nm) | plate (N/m) | plate (N/m) | (%) | C. (%) | (%) |
| Embodiment 0 | 30 | 9.2 | 12.6 | 89.5 | 75.3 | 92.5 |
| Embodiment 1 | 60 | 10.5 | 14.2 | 91.5 | 77.4 | 95.3 |
| Embodiment 2 | 20.5 | 8.8 | 12.3 | 89.2 | 75.2 | 92.1 |
| Embodiment 3 | 40.3 | 9.6 | 13.4 | 90.8 | 76.3 | 94.3 |
| Embodiment 4 | 80 | 10.8 | 14.5 | 91.4 | 77.3 | 95.1 |
| Embodiment 5 | 100 | 11.1 | 15.3 | 91.2 | 77.1 | 94.9 |
| Comparative | / | 2.1 | 1.5 | 80.6 | 73.1 | 83.2 |
| Embodiment 1 | | | | | | |
| Comparative | 18.2 | 3.4 | 5.6 | 84.2 | 71.1 | 82.4 |
| Embodiment 2 | | | | | | |
| Comparative | 110.1 | 4.2 | 5.9 | 85.6 | 72.3 | 81.8 |
| Embodiment 3 | | | | | | |

As can be seen from Table 1 and Table 2, by adjusting the average diameter of the protrusions on the surfaces of the bonded particles to make the average diameter of the protrusions within an appropriate range, bonding forces between the separator and the positive electrode plate as well as between the separator and the negative electrode plate are increased, and the cycle performance, low-temperature performance and rate performance of the lithium-ion battery are further significantly improved. In Comparative Embodiment 1, no bonded particles and no protrusions are formed.

TABLE 3

| | Temperature | | Bonding force | Bonding force | | | |
|---|---|---|---|---|---|---|---|
| | of separator | | between | between | | Low-temperature | |
| | soaked in | | separator | separator | 800th-cycle | capacity | |
| | electrolyte | | and positive | and negative | performance | retention | Rate |
| | solution | Number of | electrode | electrode | at 25° C. | rate at −20° | performance |
| | (° C.) | protrusions | plate (N/m) | plate (N/m) | (%) | C. (%) | (%) |
| Embodiment 1 | 70 | 30 | 10.5 | 14.2 | 91.5 | 77.4 | 95.3 |
| Embodiment 6 | 60 | 3 | 4.3 | 6.7 | 86.8 | 74.9 | 95.8 |
| Embodiment 7 | 64 | 5 | 5.4 | 7.8 | 87.8 | 79.6 | 95.8 |
| Embodiment 8 | 66 | 10 | 7.8 | 10.3 | 89.9 | 79.4 | 95.6 |
| Embodiment 9 | 68 | 20 | 8.6 | 12.4 | 90.8 | 78.6 | 95.5 |
| Embodiment 10 | 72 | 40 | 11.4 | 14.5 | 91.2 | 77.1 | 94.8 |
| Embodiment 11 | 75 | 50 | 11.8 | 14.9 | 90.2 | 75.4 | 92.9 |
| Embodiment 12 | 78 | 60 | 12.1 | 14.8 | 89 | 75 | 91 |

As can be seen from the above Table 3, by changing the temperature of the separator soaked in the electrolyte solution, the number of the protrusions is adjusted. When the number of the protrusions is within a range of 5 to 50, there are good bonding forces between the separator and the positive electrode plate as well as between the separator and the negative electrode plate, and the prepared lithium-ion battery has good cycle performance, low-temperature performance, and rate performance.

TABLE 4

| | | | | Bonding force | Bonding force | | | |
|---|---|---|---|---|---|---|---|---|
| | Coating weight | | | between | between | | Low-temperature | |
| | per unit area | | Average | separator | separator | | capacity | |
| | of bonding | Number | diameter of | and positive | and negative | 800th-cycle | retention | Rate |
| | layer | of bonded | protrusions | electrode | electrode | performance | rate at −20° | performance |
| | (mg/5000 mm2) | particles | (nm) | plate (N/m) | plate (N/m) | at 25° C. (%) | C. (%) | (%) |
| Embodiment 4 | 1 | 40 | 80 | 10.8 | 14.5 | 91.4 | 77.3 | 95.1 |
| Embodiment 13 | 0.125 | 5 | 80 | 4.3 | 6.7 | 89.4 | 78.3 | 95.1 |
| Embodiment 14 | 0.26 | 10 | 80 | 4.5 | 6.8 | 89.6 | 78.5 | 95.2 |
| Embodiment 15 | 0.51 | 20 | 80.3 | 6.8 | 10.3 | 90.8 | 78.4 | 95.6 |
| Embodiment 16 | 1.125 | 50 | 80.1 | 11.3 | 14.7 | 91.1 | 77.1 | 94.7 |
| Embodiment 17 | 1.6 | 60 | 80 | 11.7 | 14.9 | 90.7 | 76.8 | 94.5 |
| Embodiment 18 | 1.75 | 70 | 80.2 | 11.9 | 15 | 90.2 | 76.3 | 94.2 |

In Table 4, as can be seen from Embodiment 4, and Embodiment 13 to Embodiment 18, by adjusting the coating weight per unit area of the bonding layer, when the number of the bonded particles is within a range of 10 to 60, good bonding forces are maintained between the separator and the positive electrode plate as well as between the separator and the negative electrode plate, and meanwhile, the lithium-ion battery prepared therefrom has good cycle performance, low-temperature performance, and rate performance.

TABLE 5

| | Particle | Particle | | | Bonding force | Bonding force | | | |
|---|---|---|---|---|---|---|---|---|---|
| | size Dv50 | size Dv90 | Thickness | | between | between | | Low-temperature | |
| | of | of | of | Average | separator | separator | 800th-cycle | capacity | |
| | inorganic | inorganic | inorganic | diameter of | and positive | and negative | performance | retention rate | Rate |
| | particles | particles | coating | protrusions | electrode | electrode | at 25° C. | at −20° C. | performance |
| | (μm) | (μm) | (μm) | (nm) | plate (N/m) | plate (N/m) | (%) | (%) | (%) |
| Embodiment 1 | 1.09 | 1.91 | 2 | 60 | 10.5 | 14.2 | 91.5 | 77.4 | 95.3 |
| Embodiment 19 | 0.45 | 0.56 | 0.5 | 60 | 11.2 | 14.3 | 91.4 | 77.3 | 95.1 |
| Embodiment 20 | 1.09 | 1.45 | 1.5 | 60.1 | 11.4 | 14.5 | 91.8 | 77.7 | 95.1 |
| Embodiment 21 | 1.09 | 1.91 | 2.5 | 60 | 11.4 | 14.5 | 91.2 | 77.1 | 94.7 |
| Embodiment 22 | 1.09 | 1.91 | 3 | 60.2 | 11.4 | 14.5 | 90.9 | 77 | 94.6 |
| Embodiment 23 | 1.09 | 1.91 | 5 | 60 | 10.8 | 14.5 | 89.8 | 76.5 | 94.1 |

In the above Table 5, as can be seen from Embodiment 1, and Embodiment 19 to Embodiment 23, at different thicknesses of the inorganic coating, the separator maintains good bonding forces with the positive electrode plate and the negative electrode plate, respectively, and the lithium-ion battery prepared therefrom also has excellent cycle performance, low-temperature performance, and rate performance.

TABLE 6

| | | Bonding force | Bonding force | | | |
|---|---|---|---|---|---|---|
| | Average | between | between | | | |
| | diameter | separator | separator | | Low-temperature | |
| | of bonded | and positive | and negative | 800th-cycle | capacity | Rate |
| | particles | electrode | electrode | performance | retention rate | performance |
| | (μm) | plate (N/m) | plate (N/m) | at 25° C. (%) | at −20° C. (%) | (%) |
| Embodiment 1 | 0.60 | 10.5 | 14.2 | 91.5 | 77.4 | 95.3 |
| Embodiment 24 | 0.40 | 12.5 | 15.8 | 91.3 | 76.7 | 94.6 |
| Embodiment 25 | 0.80 | 9.8 | 12.5 | 92.1 | 77.9 | 95.1 |
| Embodiment 26 | 1.00 | 8.5 | 11.1 | 92.1 | 77.9 | 95.8 |
| Embodiment 27 | 1.10 | 8.1 | 10.8 | 91.9 | 77.8 | 95.7 |

In the above Table 6, as can be seen from Embodiment 1, and Embodiment 24 to Embodiment 27, when the bonded particles have different average diameters, the separator maintains good bonding forces with the positive electrode plate and the negative electrode plate, respectively, and meanwhile, the lithium-ion battery prepared therefrom has excellent cycle performance, low-temperature performance, and rate performance.

TABLE 7

| | | Content | Bonding force | Bonding force | | | |
|---|---|---|---|---|---|---|---|
| | | percent of | between | between | | | |
| | | connected | separator | separator | | Low-temperature | |
| | Polymer monomers | bonded | and positive | and negative | 800th-cycle | capacity | Rate |
| | forming bonded | particles | electrode | electrode | performance | retention rate | performance |
| | particles | (%) | plate (N/m) | plate (N/m) | at 25° C. (%) | at −20° C. (%) | (%) |
| Embodiment 1 | 5% of methyl acrylate, | 70.6 | 10.5 | 14.2 | 91.5 | 77.4 | 95.3 |
| | 78% of styrene, 2% of | | | | | | |
| | butadiene, and 15% of | | | | | | |
| | isobutyl acrylate | | | | | | |
| Embodiment 28 | 5% of methyl acrylate, | 40 | 10 | 14.2 | 88 | 77 | 94.3 |
| | 85% of styrene, 2% of | | | | | | |
| | butadiene, and 8% of | | | | | | |
| | isobutyl acrylate | | | | | | |
| Embodiment 29 | 5% of methyl acrylate, | 50.5 | 10.5 | 14.2 | 88.7 | 76.8 | 94.2 |
| | 84% of styrene, 2% of | | | | | | |
| | butadiene, and 9% of | | | | | | |
| | isobutyl acrylate | | | | | | |
| Embodiment 30 | 5% of methyl acrylate, | 90.2 | 11 | 14.2 | 93.4 | 78.1 | 95.1 |
| | 76% of styrene, 2% of | | | | | | |
| | butadiene, and 17% of | | | | | | |
| | isobutyl acrylate | | | | | | |
| Embodiment 31 | 5% of methyl acrylate, | 95.0 | 11.2 | 14.2 | 93.5 | 78 | 94.9 |
| | 75% of styrene, 2% of | | | | | | |
| | butadiene, and 18% of | | | | | | |
| | isobutyl acrylate | | | | | | |

In Table 7, as can be seen from Embodiment 1 and Embodiments 28 to 31, when the content of the connected bonded particles is within an appropriate range, the separator maintains good bonding forces with the positive electrode plate and the negative electrode plate, respectively, and meanwhile, the lithium-ion battery prepared therefrom has excellent cycle performance, low-temperature performance, and rate performance.

TABLE 8

| | | Bonding force | Bonding force | | | |
|---|---|---|---|---|---|---|
| | | between | between | | | |
| | Porosity | separator | separator | | Low-temperature | |
| | of | and positive | and negative | 800th-cycle | capacity | Rate |
| | separator | electrode | electrode | performance | retention rate | performance |
| | (%) | plate (N/m) | plate (N/m) | at 25° C. (%) | at −20° C. (%) | (%) |
| Embodiment 1 | 42.5 | 10.5 | 14.2 | 91.5 | 77.4 | 95.3 |
| Embodiment 32 | 30.2 | 10.1 | 13.2 | 93.1 | 77.9 | 94.8 |
| Embodiment 33 | 50.1 | 12.1 | 14.9 | 94.5 | 77.5 | 93.2 |

In Table 8, as can be seen from Embodiment 1, and Embodiments 32 and 33, when the porosity of the separator is within an appropriate range, the separator maintains good bonding forces with the positive electrode plate and the negative electrode plate, respectively, and meanwhile, the lithium-ion battery prepared therefrom has excellent cycle performance, low-temperature performance, and rate performance.

TABLE 9

| | | Bonding force | Bonding force | | | |
|---|---|---|---|---|---|---|
| | | between | between | | | |
| | | separator | separator | | Low-temperature | |
| | Transmittance | and positive | and negative | 800th-cycle | capacity | Rate |
| | of bonding | electrode | electrode | performance | retention rate | performance |
| | layer (%) | plate (N/m) | plate (N/m) | at 25° C. (%) | at −20° C. (%) | (%) |
| Embodiment 1 | 80 | 10.5 | 14.2 | 91.5 | 77.4 | 95.3 |
| Embodiment 34 | 49.5 | 10 | 14.2 | 90 | 77.2 | 95.2 |
| Embodiment 35 | 95.2 | 10.7 | 14.2 | 91.8 | 77.7 | 95.4 |
| Embodiment 36 | 42.5 | 9.8 | 14.2 | 89.3 | 77 | 94.4 |

In the above Table 9, by adjusting the percent of carboxyl groups grafted to the bonded particles in the bonding layer, the transmittance of the bonding layer is adjusted. When the transmittance is within an appropriate range, the separator maintains good bonding forces with the electrode plates, and the lithium-ion battery prepared therefrom also has excellent cycle performance, low-temperature performance, and rate performance.

TABLE 10

| | | | | | Bonding force | Bonding force | | | |
|---|---|---|---|---|---|---|---|---|---|
| | Particle | Particle | | | between | between | | Low-temperature | |
| | size Dv50 | size Dv90 | Thickness | | separator | separator | 800th-cycle | capacity | |
| | of inorganic | of inorganic | of inorganic | | and positive | and negative | performance | retention rate | Rate |
| | particles | particles | coating | | electrode | electrode | at 25° C. | at −20° C. | performance |
| | (μm) | (μm) | (μm) | d1/d2 | plate (N/m) | plate (N/m) | (%) | (%) | (%) |
| Embodiment 1 | 1.09 | 1.91 | 2 | 0.4 | 10.5 | 14.2 | 91.5 | 77.4 | 95.3 |
| Embodiment 37 | 0.45 | 0.56 | 0.5 | 0.05 | 10.8 | 12.5 | 90.5 | 76.5 | 92.4 |
| Embodiment 38 | 1.09 | 1.91 | 2 | 0.20 | 10.5 | 14.2 | 91.9 | 77.6 | 94.5 |
| Embodiment 39 | 1.09 | 1.91 | 2 | 0.29 | 10.5 | 14.2 | 91.2 | 77.1 | 94.1 |
| Embodiment 40 | 1.09 | 1.91 | 2 | 0.60 | 10.5 | 14.2 | 91.3 | 77.2 | 94.3 |
| Embodiment 41 | 1.09 | 1.91 | 2 | 0.95 | 10.3 | 13.9 | 90.1 | 75.6 | 93.2 |

In Table 10, as can be seen from Embodiment 1, and Embodiment 36 to Embodiment 40, d1/d2 is within an appropriate range, the separator maintains good bonding forces with the electrode plates, and the lithium-ion battery prepared therefrom also has excellent cycle performance, low-temperature performance, and rate performance.

TABLE 11

| | | Bonding force | Bonding force | | | |
|---|---|---|---|---|---|---|
| | | between | between | | | |
| | | separator | separator | | Low-temperature | |
| | Polymer monomers | and positive | and negative | 800th-cycle | capacity | Rate |
| | forming bonded | electrode | electrode | performance | retention rate | performance |
| | particles | plate (N/m) | plate (N/m) | at 25° C. (%) | at −20° C. (%) | (%) |
| Embodiment 1 | 5% of methyl acrylate, | 10.5 | 14.2 | 91.5 | 77.4 | 95.3 |
| | 78% of styrene, 2% of | | | | | |
| | butadiene, and 15% of | | | | | |
| | isobutyl acrylate | | | | | |
| Embodiment 42 | 85% of styrene and 15% | 10.9 | 12.4 | 91.4 | 77.5 | 94.3 |
| | of isobutyl acrylate | | | | | |
| Embodiment 43 | 80% of styrene and 20% | 11.4 | 13.5 | 91.7 | 77.8 | 94.1 |
| | of isobutyl acrylate | | | | | |

In Table 11, as can be seen from Embodiment 1, and Embodiment 42 to Embodiment 43, by changing the types and percents of the polymer monomers forming the bonded particles, the separator maintains good bonding forces with the electrode plates, and the lithium-ion battery prepared therefrom also has excellent cycle performance, low-temperature performance, and rate performance.

The above disclosure is only a better embodiment of this application, of course, can not be used to limit this application, so the equivalent changes made in accordance with this application are still covered by the scope of this application.

What is claimed is:

1. A separator, comprising a substrate layer, an inorganic coating, and a bonding layer; wherein the inorganic coating is disposed between the substrate layer and the bonding layer, and the bonding layer contains a plurality of bonded particles, a surface of each bonded particle containing a plurality of protrusions, an average diameter of the protrusions ranges from 20 nm to 100 nm.

2. The separator according to claim 1, wherein the average diameter of the protrusions ranges from 40 nm to 100 nm.

3. The separator according to claim 1, wherein a part of a total number of the bonded particles are connected to an adjacent bonded particle, and a number of bonded particles connected to the adjacent bonded particles account for 50% to 100% of the total number of the bonded particles.

4. The separator according to claim 1, wherein an absorption peak of —COOH is presented at 1680 to 1750 cm⁻¹ in an infrared spectrum of the bonding layer, and transmittance of the absorption peak is 50% to 95%.

5. The separator according to claim 1, wherein in a scanning electron microscope image of the separator at a magnification of 10⁴, within an area of 11.6 μm×7.6 μm, the separator satisfies at least one of the following conditions:
(1) a number of the bonded particles is 10 to 60; or
(2) a number of protrusions contained in each bonded particle is 5 to 50.

6. The separator according to claim 1, wherein the inorganic coating comprises inorganic particles and a binder; wherein the inorganic particles comprise at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide, or barium sulfate;
the binder comprises at least one of acrylic acid, methyl methacrylate, butyl acrylate, octyl acrylate, isooctyl acrylate, butadiene, or acrylonitrile; and
based on a mass of the inorganic coating, a mass percentage of the inorganic particles is 85% to 95%.

7. The separator according to claim 1, wherein the bonded particles are formed by polymerization of at least two monomers selected from: butadiene, methyl acrylate, methyl methacrylate, styrene, butyl methacrylate, isooctyl acrylate, ethylene, propylene, or vinylidene fluoride.

8. The separator according to claim 1, wherein the separator satisfies at least one of the following conditions:
(1) the inorganic coating has a thickness of 0.5 μm to 5 μm;
(2) the bonded particles have an average diameter of 600 nm to 1000 nm;
(3) the inorganic particles in the inorganic coating have a particle size Dv50 of 0.4 μm to 1 μm and a particle size Dv90 of 0.8 μm to 4 μm;
(4) the bonding layer has a thickness of 0.5 μm to 2 μm and the bonding layer has a coating weight per unit area of 0.5 mg/5000 mm² to 3 mg/5000 mm²;
(5) the inorganic coating has a thickness of d1, and the substrate layer has a thickness of d2, and 0.05≤d1/d2≤1.0; and
(6) the bonding layer further comprises at least one of acrylic acid, acrylonitrile, or butadiene.

9. The separator according to claim 1, wherein the separator has a porosity of 30% to 50%.

10. The separator according to claim 1, wherein the bonded particles are formed by swelling polymer particles; and at 60° C., a degree of swelling of the polymer particles in carboxylate after 24 h is 100% to 300%; and
the carboxylate comprises at least one of methyl formate, ethyl formate, methyl acetate, ethyl acetate, propyl acetate, methyl propionate, ethyl propionate, or propyl propionate.

11. An electrochemical apparatus, comprising an electrode assembly, wherein the electrode assembly comprises a positive electrode plate and a negative electrode plate; wherein the electrode assembly further comprises a separator, the separator is located between the positive electrode plate and the negative electrode plate;
wherein the separator comprises a substrate layer, an inorganic coating, and a bonding layer; wherein the inorganic coating is disposed between the substrate layer and the bonding layer, and the bonding layer contains a plurality of bonded particles, a surface of each bonded particle containing a plurality of protrusions, an average diameter of the protrusions ranges from 20 nm to 100 nm.

12. The electrochemical apparatus according to claim 11, wherein the average diameter of the protrusions ranges from 40 nm to 100 nm.

13. The electrochemical apparatus according to claim 11, wherein a part of a total number of the bonded particles are connected to an adjacent bonded particle, and a number of bonded particles connected to the adjacent bonded particles accounts for 50% to 100% of the total number of the bonded particles.

14. The electrochemical apparatus according to claim 11, wherein an absorption peak of —COOH is presented at 1680 to 1750 cm⁻¹ in an infrared spectrum of the bonding layer, and transmittance of the absorption peak is 50% to 95%.

15. The electrochemical apparatus according to claim 11, wherein in a scanning electron microscope image of the separator at a magnification of 10⁴, within an area of 11.6 μm×7.6 μm, the separator satisfies at least one of the following conditions:
(1) a number of the bonded particles is 10 to 60; or
(2) a number of protrusions contained in each bonded particle is 5 to 50.

16. The electrochemical apparatus according to claim 11, wherein the inorganic coating comprises inorganic particles and a binder, wherein the inorganic particles comprise at least one of aluminum oxide, silicon dioxide, magnesium oxide, titanium oxide, hafnium dioxide, tin oxide, cerium dioxide, nickel oxide, zirconium oxide, zinc oxide, calcium oxide, boehmite, aluminum hydroxide, magnesium hydroxide, calcium hydroxide, or barium sulfate;
the binder comprises at least one of acrylic acid, methyl methacrylate, butyl acrylate, octyl acrylate, isooctyl acrylate, butadiene, or acrylonitrile; and
based on a mass of the inorganic coating, a mass percent of the inorganic particles is 85% to 95%.

17. The electrochemical apparatus according to claim 11, wherein the bonded particles are formed by polymerization of at least two monomers selected from: butadiene, methyl acrylate, methyl methacrylate, styrene, butyl methacrylate, isooctyl acrylate, ethylene, propylene, or vinylidene fluoride.

18. The electrochemical apparatus according to claim 11, wherein the separator satisfies at least one of the following conditions:
(1) the inorganic coating has a thickness of 0.5 μm to 5 μm;
(2) the bonded particles have an average diameter of 600 nm to 1000 nm;
(3) the inorganic particles in the inorganic coating have a particle size Dv50 of 0.4 μm to 1 μm and a particle size Dv90 of 0.8 μm to 4 μm;
(4) the bonding layer has a thickness of 0.5 μm to 2 μm and the bonding layer has a coating weight per unit area of 0.5 mg/5000 mm² to 3 mg/5000 mm²;
(5) the inorganic coating has a thickness of d1, and the substrate layer has a thickness of d2, and 0.05≤d1/d2≤1.0; and
(6) the bonding layer further comprises at least one of acrylic acid, acrylonitrile, or butadiene.

19. The electrochemical apparatus according to claim 11, wherein the separator has a porosity of 30% to 50%.

20. An electronic apparatus, comprising an electrochemical apparatus, wherein the electrochemical apparatus comprises an electrode assembly, wherein the electrode assembly comprises a positive electrode plate and a negative electrode plate; wherein the electrode assembly further comprises a separator, the separator is located between the positive electrode plate and the negative electrode plate;
wherein the separator comprises a substrate layer, an inorganic coating, and a bonding layer; wherein the inorganic coating is disposed between the substrate layer and the bonding layer, and the bonding layer contains a plurality of bonded particles, a surface of each bonded particle containing a plurality of protrusions, an average diameter of the protrusions ranges from 20 nm to 100 nm.
